(19) United States
(12) Patent Application Publication
(10) Pub. No.: US 2008/0196630 A1
(43) Pub. Date: Aug. 21, 2008

(54) ADHESIVE GROUND FORMULA FOR WATERCOLOR SURFACES

(76) Inventors: Douglas Enns, Kelowna (CA); Floyd Armstrong, Kelowna (CA)

Correspondence Address: OYEN, WIGGS, GREEN & MUTALA LLP;480 - THE STATION, 601 WEST CORDOVA STREET, VANCOUVER, BC, V6B 1G1, CA

(21) Appl. No.: 12/030,712

(22) Filed: Feb. 13, 2008

Related U.S. Application Data
(60) Provisional application No. 60/889,597, filed on Feb. 13, 2007.

(51) Int. Cl. C04B 14/10; B05D 3/12

(52) U.S. Cl. 106/773; 427/299

(57) ABSTRACT

This invention relates to a novel process and composition for treating the surface of an ABS or other polymer sheet so that it will accept watercolor paints. More particularly, this invention involves using a series of adhesive ground compounds to modify the surface of the ABS polymer or other sheet so that it becomes water absorbent to a certain degree. A method of treating the surface of a polymer so that it is acceptable for watercolor pigments comprising: (a) roughening the surface of the polymer; (b) applying a layer of a mixture of soft gel gloss and kaolin clay to the roughened surface and allowing it to dry; (c) applying a second layer of soft gel gloss and kaolin clay mixture to the first layer of soft gel gloss and kaolin clay mixture and allowing it to dry; and (d) applying a layer of absorbent watercolor ground to the kaolin clay layer.

### FIELD OF THE INVENTION

This invention relates to a novel process and composition for treating the surface of an ABS or other polymer sheet so that it will accept watercolor paints. More particularly, this invention involves using soft gel gloss and adhesive ground compounds to modify the surface of the ABS polymer or other polymer sheet so that it becomes water absorbent to a certain degree and accepts watercolor pigments.

### BACKGROUND OF THE INVENTION

One of the problems facing artists who paint in watercolor is that to get bright effective colors they must apply the watercolor pigments to a water absorbable surface. Usually this surface is a cellulose fibre based paper which is subject to swelling, puckering and deterioration with age. Another problem is that the watercolor pigments fade upon exposure to ultra-violet light. In order to protect the watercolor painting from ultra-violet light, watercolor paintings have traditionally been framed under glass. This is a disadvantage in selling and marketing the watercolor paintings. Many art collectors prefer to be able to touch and feel the painting. This glass protection problem does not arise with oil and acrylic paintings, which are ultra-violet resistant and thus do not need to be mounted under glass.

The following patents and applications disclose subject matter which is of more or less relevance to the subject invention:

| | Issue/ | |
|---|---|---|
| Patent/Publication No. | Publication Date | Inventor(s) |
| U.S. Pat. No. 6,423,379 B1 | 23 Jul. 2002 | Ewing |
| U.S. Pat. No. 6,258,412 B1 | 10 Jul. 2001 | Ewing |
| US 2003/0035917 A1 | 20 Feb. 2003 | Hyman |
| U.S. Pat. No. 4,065,596 | 27 Dec. 1977 | Groody |
| U.S. Pat. No. 4,207,366 | 10 Jun. 1980 | Tyler |
| WO 2005/047020 A2 | 26 May 2005 | January |
| WO 88/02702 | 21 Apr. 1988 | Hermann |
| U.S. Pat. No. 6,410,097 B2 | 25 Jun. 2002 | Kume et al. |
| U.S. Pat. No. 5,491,020 | 13 Feb. 1996 | Ide et al. |
| U.S. Pat. No. 2,555,506 | 5 Jun. 1951 | Powers |

U.S. Pat. No. 6,423,379 B1, Ewing, discloses a mineral-based coating composition that can be used on a wide range of substrate surfaces. The composition is comprised of a mineral extender, such as delaminated hydrated aluminum silicate based clays, having an aspect ratio of about 11 to 1, water, a homopolymer polyvinyl acetate emulsion, a co-polymer polyvinyl acetate emulsion, an acrylic emulsion binder containing a metal dioxide and a buffering agent, a surfactant and a defloculant. Also disclosed is a method of preparing the mineral-based coating composition. The mineral-based coating composition may be applied to various substrate surfaces to form artistic medium surfaces.

The media for artistic expression specifically comprises preparing a mineral-based coating composition comprising kaolin clay, mica, talc, montmorillonite atapulgite, illite, bentonite or halloysite mineral extender, water, a polyvinyl acetate emulsion and acrylic polymer binder. This mixture is applied as a sealing coat to a backing material. A second layer is applied to the first layer. The combination is then dried. The backing material is stated to be either hardboard, plastic or acrylic plastic. There does not appear to be any mention of ABS polymer.

U.S. Pat. No. 6,258,412 B1, Ewing, is a division of the above-named U.S. Ewing patent. The information of the applicants herein is that Mr. Ewing and his wife are co-founders of Ampersand Clayboard and panels manufactured by that company are available in the art market. The Clayboard panels are sometimes referred to as scratchboard panels. One can scratch into the panels to create a bas-relief. A disadvantage of the Clayboard panels is that over time, they evidently can deteriorate from the rear surface into the interior of the panel.

U.S. Patent Application Publication 2003/0035917 A1, Hyman, discloses an image support medium for creation of an aesthetic image that is a work or object for display. This support medium includes a polymer in an amount sufficient to enable the image to have at least one aesthetic element. In different embodiments, the image support medium is an image support stabilizer, the polymer is a synthetic absorbent or conductive polymer, or the polymer is a transparent or synthetic translucent polymer and a property of this transparent or translucent polymer is enhanced to facilitate the creation or preservation of the image by at least one stabilizer. The invention also relates to a method for preparing this image support medium. The method includes forming a reaction mixture comprising a monomer in an amount sufficient to provide or enable the image to have an aesthetic element, and processing the reaction mixture into a 2- or 3-dimensional shape.

WO 2005/047020 A2, published 26 May 2005, discloses a coated substrate suitable for accepting water-based paints, pencils, and inks, in which the substrate is coated with the coating, and the coating is formulated to accept water-based paints, pencils, and inks without unacceptable running or bleeding of the water-based paints, pencils, and inks in and on the coating. The substances disclosed in this application appear to be mainly calcium carbonate filler and an acrylic latex coating.

U.S. Pat. No. 4,065,596, Groody, discloses a laminated artist's board comprised of a rear substantially rigid backer, a front paintable member in the form of a plastic coated paper, cotton duck or linen sheet, and an intermediate flexibly resilient member wherein the range of hardness of the combined front and intermediate members is such that pressure applied on the paintable member with a brush will produce a dent of limited depth that will recover substantially instantaneously so that the artist can retain his techniques and habits of painting on canvas. The board is less expensive than canvas, is easily cropped and is resistant to humidity and/or temperature changes.

The plastic paintable surface is specifically identified as consisting of polyethylene, polypropylene, acrylic, vinyl or epoxy resins. An intermediate flexibly resilient member consisting of rubber, vulcanizates of acrylic elastomers or foam plastic is also disclosed.

U.S. Pat. No. 4,207,366, Tyler, discloses a dimensionally stable, rigid, crush-resistant non-warping, structured art surface. In one embodiment, watercolor, drawing or conservation paper is embedded as a face sheet in an adhesive on a sandwich laminate including a honeycomb core. The resulting art surface provides watercoloring, drawing, painting, screen printing or conservation surfaces of unprecedented stability. This permits one to paint, draw on screen print on relatively thin sheets of art paper without limiting the sheet in size. As conversation board the surface with its stable and rigid construction may be used for mounting original art including photographs. The art surface of the invention may also be used in the construction of a maquette.

WO 88/02702, published 21 April 1988, is stated to disclose a new kind of paint support which replaces watercolour paper or linen otherwise used for painting. This paint support has in principle three layers. The lowest layer is a cotton wool fabric covered with a non-woven fabric. Latex paint is applied on the non-woven fabric to form the topmost layer. Surface properties similar to those of linen are thus obtained, with the advantage that the support need not be stretched on a frame. It is therefore easier to handle and cheaper than linen, but does not become undulated like paper when paint is applied. It has the further advantage that the blending of colours applied thereon can be better controlled.

The foregoing examples of the related art and limitations related thereto are intended to be illustrative and not exclusive. Other limitations of the related art will become apparent to those of skill in the art upon a reading of the specification and a study of the drawings.

### SUMMARY OF THE INVENTION

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

This invention relates to artists' ABS polymer painting surfaces and specifically with respect to the application of watercolor pigments on an artist structural panel made of ABS or other types of polymer. Currently, there is no substance within the art field that is specifically designed to permanently treat the surface of a polymer such as ABS so that it will allow the artist to effectively apply water borne pigments on the polymer surface. There are currently on the market artists' ground compositions that can be used to treat polymer sheets so they are temporarily acceptable to watercolor pigments. However, with the current group of artists' ground compositions, if one or more of them are applied directly to the plastic, they can be easily removed by scraping, such as with a fingernail.

We have invented an adhesive ground formula that is a combination of archivable art products, such as soft gel gloss and a kaolin clay which adhere to the polymer surfaces so that a successive series of layers of adhesive ground can be built up. The layers of ground applied to the polymer surface are permanent and readily absorb watercolor pigments.

The invention relates to a method of treating the surface of a polymer so that it is acceptable for watercolor pigments comprising: (a) roughening the surface of the polymer; (b) applying to the roughened surface a layer of 50% soft gel gloss mixed with a 50% kaolin clay and allowing it to dry; (c) sanding layer (b) after it is dry; (d) applying to layer (b) a second layer of 50% soft gel gloss mixed with 50% kaolin clay and allowing it to dry; (e) lightly sanding the second layer (d); (f) applying to layer (d) a layer of 50% kaolin clay/water mixture and allowing it to dry; (g) lightly sanding layer (f); and (h) applying a layer of absorbent watercolor ground to the layer of kaolin clay and allowing it to dry.

The polymer can be an ABS polymer. If desired, two successive layers of adhesive ground can be applied with drying of each layer before applying a successive layer. The watercolor ground can be acrylic based to provide ultra-violet light resistance.

The method is also directed to a composition for treating the surface of an ABS polymer so that it accepts watercolor pigments comprising: (a) 50 percent soft gel gloss; and (b) 50 percent of a composition comprising: (i) 1,000 ml of water; (ii) 950 ml of kaolin clay; (iii) 800 ml of white gesso; and (iv) 80 ml of absorbent ground.

In addition to the exemplary aspects and embodiments described above, further aspects and embodiments will become apparent by reference to the drawings and by study of the following detailed descriptions.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 is, in side view, not to scale, of the ABS or polymer sheet (1) with the (2) adhesive ground formula applied, along with (3) the kaolin clay mixture applied; (4) and finished with an application of either (i) absorbent ground for watercolor (ii) acrylic gesso or (iii) absorbent ground for pastels.

FIG. 2, is in side view, not to scale, of ABS or polymer sheet (1) sanded, with only the adhesive ground formula (2) applied to the polymer surface.

### DETAILED DESCRIPTION OF THE INVENTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

The objective pursued by the inventors was to develop a watercolor painting polymer surface that would readily absorb water color pigments, could not be easily removed and would not require protection by glass. This involved discovering compounds and a method whereby the polymer painting surface could be adapted to readily absorb watercolor pigments similar to traditional watercolor paper without loss of pigment brightness and color. A further objective was to create a watercolor pigment absorbing surface that would have ultra-violet protection so that there would be no need to frame the watercolor painting under glass.

There is currently on the market a product called Yupo™ watercolor paper. It is not in fact a cellulose fibre based paper, but is a painting surface created of non-woven extruded polypropylene fibres. As such, the watercolor pigment, when applied to the non-woven polypropylene fibre surface, is not absorbed but simply remains upon the top surface. Many watercolor artists have been concerned about using this product because of its inability to absorb the watercolor pigment, as with traditional cellulose fibre papers.

Polymer art panels, and particularly ABS polymers, have the advantage that they are durable and withstand exposure to light and various quality deteriorating agents such as cleaners. Polymer panels such as ABS polymers can be used in the same capacity as the Yupo™ paper. However, polymer panels are not water absorbent and for watercolors, the polymer panels must be able to absorb the watercolor pigment similar to conventional cellulose fibre watercolor papers. The medium should also be able to provide protection from ultra-violet light, thereby eliminating the need to frame the watercolor painting under glass. Finally, the compounds used to treat the surface of the polymer should be able to be applied to all current types of supports used by the watercolorists, but in particular, should be able to adhere to the polymers, without experiencing delamination, or be easily removed.

The main component of the surface treating compounds must be permanent in nature, be of relatively low viscosity and have short rheology characteristics (buttery in nature), rather than long rheology characteristics (syrupy in nature).

We have discovered that a number of soft gel glosses that are available from a variety of art manufacturers have the foregoing characteristics. Most, if not all, of such soft gels can be used as glues. In developing our invention, we have focused on ABS polymer sheets and have conducted experiments to ensure that the product that is developed actually works on an ABS plastic surface. We have found that certain polymers, such as polypropylene and polyethylene, have waxy surfaces and are not suitable because the soft gels will not properly adhere to them. However, we have found that when the soft gel is applied to an open (sanded) surface of an ABS plastic surface, and allowed to dry, it is difficult to scrape off the ABS surface, even with a knife. We have found that Golden™ soft gel gloss, available from Golden Artist Colors Inc., New Berlin, N.Y., is satisfactory as a base layer on the roughened ABS polymer surface.

The next problem to overcome was to discover a substance which was compatible with the Golden soft gel gloss and would create a layer of absorbent film upon the surface of the ABS plastic using the Golden soft gel gloss as a base component. Although soft gel gloss has superior binding qualities and is virtually a pure binder, it is not particularly absorbent. We discovered it was necessary to add another component that would allow for further absorption of the consecutive layers of ground upon the surface of the ABS polymer. Such materials, we found, could become a built-up series of layers that would absorb the watercolor pigments. We have also found that when using the soft gel as a binder, it is necessary that it make up at least 50 percent weight of the overall composition.

Soft gels are moderately pourable so for practical reasons the second 50 percent weight component of the formula should have similar characteristics. After much trial and elimination, we discovered that kaolin clay was compatible with the soft gel and provided water absorbency. Kaolin clay is a fine, soft white clay produced by the decomposition of other clays and is available from a number of commercial sources. After experimenting for several months, we were able to develop a composition that consisted of 1,000 ml of water, mixed with 950 ml of kaolin clay, 800 ml of acrylic gesso and 80 ml of absorbent ground. Acrylic gesso and absorbent ground are also available from Golden Artist Colors Inc. An electric mixer was used to blend these components together. This combination of materials made up the second 50% absorption part of the formula, with Golden soft gel as the first 50% component. The mixture as described is pourable.

The next step in developing the formula and method was to combine the 50% weight Golden soft gel with the 50% weight kaolin clay, gesso and absorbent ground based mixture. These two products were blended together into a single mixture. This mixture was then applied to the sanded surface of the ABS polymer by using a sprayer, roller or brush and allowed to dry. We discovered that this satisfactorily formed the first layer of absorbency. Furthermore, we found that successive layers of this ground formula with drying between application could be built up to provide a water absorbent base for a watercolor painting. The minimum temperature range for applying the first coat of adhesive ground to the ABS plastic panel was discovered to be about 9° C. or 49° F. We found that applications in a temperature range lower than this compromised the integrity of the acrylic polymer soft gel component.

If multiple layers are required to increase water and pigment absorbency, a second coating of the adhesive ground formula can be applied and allowed to dry. If desired, a third layer of the same kaolin clay-based formula can be applied and dried. Finally, if desirable, one or two coats of acrylic-based absorbent ground can be applied to provide a surface on the ABS polymer surface that is reasonably permanent and is fully absorbable for watercolor pigments to the extent that the surface provides the same color characteristics as watercolor pigments applied to conventional cellulose fibre based watercolor papers. Because both the soft gel gloss and the acrylic-based absorbent ground are composed of 100% acrylic polymers, they provide excellent ultra-violet resistance. Furthermore, since they are an inherent component of the several layers of ground that absorb the watercolor pigments, they do not lose their ultra-violet resistance.

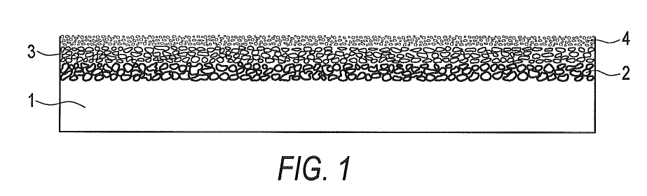

Referring to FIG. 1, which illustrates an enlarged cross-section of an ABS polymer sheet treated with the compounds and processes according to one embodiment of the invention, the watercolor absorbable layer on the ABS polymer sheet 1 is built up by first applying a layer of adhesive ground formula 2. This is followed by two successive coats of kaolin clay formula 3. Finally, finishing coats of absorbent ground for watercolor, acrylic gesso or absorbent ground for pastels 4 are applied.

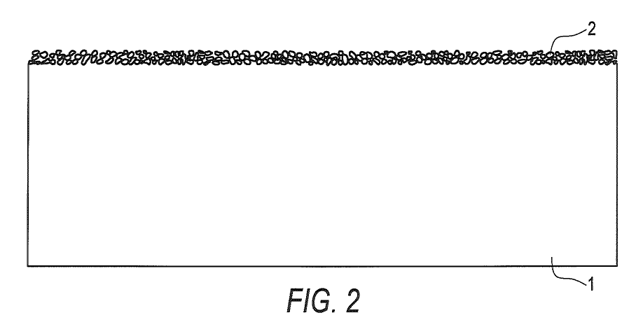

FIG. 2, is a side view, not to scale, of a sanded ABS or polymer sheet (1) with only the adhesive ground formula (2) applied to the polymer surface.

### EXAMPLE 1

Art Spectrum Colourfix Primer manufactures a pastel and multimedia primer. Armadillo Art & Craft, 115 Stryker Lane Building 4, Units 8-9, Hillsborough, N.J. distributes this product in North America. The label affixed to this product states: “Art Spectrum fine tooth Colourfix primer is a quick drying acrylic primer which aggressively bonds to practically any clean surface: paper, canvas, card, plywood, ceramic, even plastic, glass or metal. Colourfix Primer colours can be intermixed to create new colour, or tinted to your own specifications using Art Spectrum inks, gouache or watercolor”.

We applied the Art Spectrum Rose Grey multimedia primer directly to the surface of an 11 in.×14 in. ABS panel. We then allowed the product to dry the same amount of time that we use for our adhesive ground formula to dry. We were able to scrape the Art Spectrum primer off of the ABS panel, using our fingernails. In contrast, we were not able to remove our adhesive ground formula from a corresponding ABS panel. To get the same adhesion from the Art Spectrum primer, we had to wait for over six days for the product to cure fully to the ABS panel and yet, we were still able to scrape away some of the primer from the ABS surface using our fingernails.

### EXAMPLE 2

We continued to run tests on their ABS coated product, to test the overall adhesion quality to the ABS art and cradle panels. We prepared three 11 in.×14 in.×⅛ in. art cradle panels with the seven coats of product, gesso finish. We allowed the panels to cure for seven days, then attempted to remove the seven layers from the ABS cradle panels. The first test run was conducted on Dec. 21, 2006. We used a ⅓ sheet electric sander with fresh sheets of 80-grit sandpaper for each panel. Reproduced below are the following removal results:

| | Temperature | Start Time | Finish Time | Removal Time |
|---|---|---|---|---|
| PANEL A | 5° C. | 1:30 p.m. | 1:39 p.m. | 8 min., 15 sec. |
| PANEL B | 5° C. | 1:50 p.m. | 1:58 p.m. | 7 min., 45 sec. |
| PANEL C | 4° C. | 2:16 p.m. | 2:35 p.m. | 18 min., 5 sec. |

The above results confirm that it is difficult to remove our formula from the ABS panel surface. These times were based on removal right down to the ABS surface completely. We were also able to sand down to the Kaolin clay-based coats. This is advantageous because in the future, art conservationists will be able to lift the paint layers at the Kaolin clay-based point if, for some reason, the entire work of art must be restored and remounted.

### EXAMPLE 3

We also ran another test using the same criteria as in the first three panels in Example 2 on a fourth 11 in.×14 in.×⅛ in. ABS cradle panel with a similar gesso finish. This test was conducted on Dec. 28, 2006. We used the same ⅓ sheet electric sander with a fresh sheet of 80-grit sandpaper. The outside temperature was −5° C. and Panel D took a total of 18 minutes and 5 seconds to completely sand down to the ABS surface of the cradle. It is evident from this test that the colder it gets, the more difficult it is to remove the seven coats of artistic ground, using our adhesive ground formula as the key to setting up the finished product.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. A method of treating the surface of a polymer so that it is acceptable for watercolor pigments comprising:
(a) roughening the surface of the polymer;
(b) applying to the roughened surface a layer of 50% soft gel gloss mixed with a 50% kaolin clay and allowing it to dry;
(c) sanding layer (b) after it is dry;
(d) applying to layer (b) a second layer of 50% soft gel gloss mixed with 50% kaolin clay and allowing it to dry;
(e) lightly sanding the second layer (d);
(f) applying to layer (d) a layer of 50% kaolin clay/water mixture and allowing it to dry;
(g) lightly sanding layer (f); and
(h) applying a layer of absorbent watercolor ground to the kaolin clay layer and allowing it to dry.

2. A method as claimed in claim 1 wherein the polymer is an ABS polymer.

3. A method as claimed in claim 2 wherein two successive layers of adhesive ground are applied with drying each layer before applying a successive layer.

4. A method of treating the surface of a polymer so that it is acceptable for watercolor pigments wherein the surface is treated with a composition comprising 50 percent soft gel gloss and 50 percent kaolin clay, acrylic gesso, absorbent ground and water.

5. A composition for treating the surface of an ABS polymer so that it accepts watercolor pigments comprising:
(a) 50 percent soft gel gloss; and
(b) 50 percent of a composition comprising:
(i) 1,000 ml of water;
(ii) 950 ml of kaolin clay;
(iii) 800 ml of white gesso; and
(iv) 80 ml of water absorbent ground.
